(19) United States
(12) Patent Application Publication
(10) Pub. No.: US 2026/0359489 A1
(43) Pub. Date: Nov. 12, 2026

(54) INFORMATION PROCESSING TERMINAL, MACHINE LEARNING METHOD, INFORMATION PROCESSING METHOD, AND PROGRAM

(71) Applicant: NTT, Inc., Tokyo (JP)

(72) Inventors: Iifan TYOU, Tokyo (JP); Tomohiro INOUE, Tokyo (JP); Naoto KIRIBUCHI, Tokyo (JP); Nami ASHIZAWA, Tokyo (JP); Ryohei SUZUKI, Tokyo (JP); Daigoro YOKOZEKI, Tokyo (JP)

(21) Appl. No.: 19/111,895

(22) PCT Filed: Sep. 20, 2022
(86) PCT No.: PCT/JP2022/034987

§ 371 Date: Mar. 14, 2025

(51) Int. Cl. G06F 21/64

(52) U.S. Cl. CPC G06F 21/64

(57) ABSTRACT

An object of the present disclosure is to reduce costs for storage usage, network communication, incentive for participants, and the like while ensuring the security of existence proof (time stamp).

Thus, it is an information processing terminal that performs an electronic signature based on existence proof, the information processing terminal including a participation management unit by which each of participants of the electronic signature individually generates a random number, and participates as an information processing terminal related to a signer in a case where the random number is less than a threshold value.

### TECHNICAL FIELD

The present disclosure relates to a technology for performing electronic signature based on existence proof (time stamp) in information processing terminals of a plurality of signers.

### BACKGROUND ART

In recent years, there has been demand for data utilization in artificial intelligence (AI), and motivation for utilization is spreading throughout society. On the other hand, due to an insufficient amount of data, security concerns regarding data sharing, and the like, practical application has not progressed. In order to solve this issue, there is demand for a data distribution infrastructure that anyone can use safely and inexpensively.

In addition, the data distribution infrastructure includes a centralized model in which a trusted third party (TPP) such as a service provider is trusted to perform all processing on behalf of the third party, and a decentralized model in which a participant verifies security by validation without trusting others. Considering a current state in which data sharing does not proceed due to concerns such as abuse of data by a service provider, a decentralized data distribution infrastructure that does not rely on trust with others is desirable. As the decentralized data distribution infrastructure, Bitcoin and Blockene (Non-Patent Literature 1 and 2) using a blockchain, and a method of constructing a ledger infrastructure based on a decentralized directed graph (DAG) for improving cost and performance (Non-Patent Literature 3) are known.

As an important function of the data distribution infrastructure, there is “existence proof (time stamp)” for proving that data existed at a certain time, but in the above method, in a case where there is no trust for the signer (that is, in a case where no third party (trusted third party (TTP)) trusted in a decentralized manner is not assumed), security of the existence proof cannot be verified.

Accordingly, in order to safely perform existence proof in the decentralized data distribution infrastructure, methods for ensuring security by using data sharing and consensus processing (Non-Patent Literature 4, 5, and 6) have been proposed.

### CITATION LIST

### Non-Patent Literature

Non-Patent Literature 1: Satoshi Nakamoto, “Bitcoin: A Peer-to-Peer Electronic Cash System”
Non-Patent Literature 2: Sambhav Satija, Apurv Mehra, Sudheesh Singanamalla, Karan Grover, Muthian Sivathanu, Nishanth Chandran, Divya Gupta, and Satya Lokam. 2020. Blockene: a high-throughput blockchain over mobile devices. Proceedings of the 14th USENIX Conference on Operating Systems Design and Implementation. USENIX Association, USA, Article 32, 567-582.
Non-Patent Literature 3: Wang, Q., Yu, J., Chen, S., and Xiang, Y., “SoK: Diving into DAG-based Blockchain Systems”, arXiv e-prints, 2020.
Non-Patent Literature 4: Colin LeMahieu, “Nano: A Feeless Distributed Cryptocurrency Network”, 2017
Non Patent Literature 5: L. Baird and A. Luykx, “The Hashgraph Protocol: Efficient Asynchronous BFT for High-Throughput Distributed Ledgers,” 2020 International Conference on Omni-layer Intelligent Systems (COINS), 2020, pp. 1-7, doi: 10.1109/COINS49042.2020.9191430.
Non Patent Literature 6: Quan Nguyen, Andre Cronje, Michael Kong, Egor Lysenko, Alex Guzev, “Lachesis: Scalable Asynchronous BFT on DAG Streams”, 2021

### SUMMARY OF INVENTION

### Technical Problem

However, in each of the techniques of Non-Patent Literature 4, 5, and 6, a blockchain of each individual or organization is shared and managed for finding a contradiction, and thus, there is a need for a large-capacity storage and a high-speed network that manage all blockchain information in a node (Node) constituting a system. The implementation of such a node is costly, the scalability is impaired, and a relationship of provision or enjoyment occurs between the node provider and the resource user. For example, the provider of the system provides resources, but in general, people who use bitcoin or the like do not provide resources by themselves, and thus the provider of the node becomes insufficient. Furthermore, it is a mechanism for ensuring security by the number of node participants and, in order to secure the number of participants, this leads to an incentive to the node provider and user cost.

The present invention has been made in view of the above points, and an object of the present invention is to reduce costs for storage usage, network communication, incentives for participants, and the like while ensuring the security of existence proof (time stamp).

### Solution to Problem

In order to solve the above problem, an invention according to claim 1 is an information processing terminal that performs electronic signature based on existence proof, the information processing terminal including a participation management unit by which each of participants of the electronic signature individually generates a random number, and participates as an information processing terminal related to a signer in a case where the random number is less than a threshold value.

### Advantageous Effects of Invention

As described above, according to the present invention, it is possible to reduce costs for storage usage, network communication, incentives for participants, and the like while ensuring the security of existence proof.

### BRIEF DESCRIPTION OF DRAWINGS

FIG. 1 is an overall configuration diagram of an existence proof system according to the present embodiment.

FIG. 2 is an electrical hardware configuration diagram of an information processing terminal according to the present embodiment.

FIG. 3 is a flowchart illustrating a concept of signature security.

FIG. 4 is a diagram illustrating a countermeasure against a forged signature by a local chain.

FIG. 5 is a sequence diagram illustrating processing of the existence proof system.

FIG. 6 is a sequence diagram illustrating processing of the existence proof system.

FIG. 7 is a flowchart illustrating processing related to a signature.

FIG. 8 is a flowchart illustrating processing related to verification that does not assume malicious behavior.

FIG. 9 is a flowchart illustrating processing related to verification that does not assume malicious behavior.

FIG. 10 is a diagram illustrating an example of content of data in each processing.

### DESCRIPTION OF EMBODIMENTS

### [System Configuration of Embodiment]

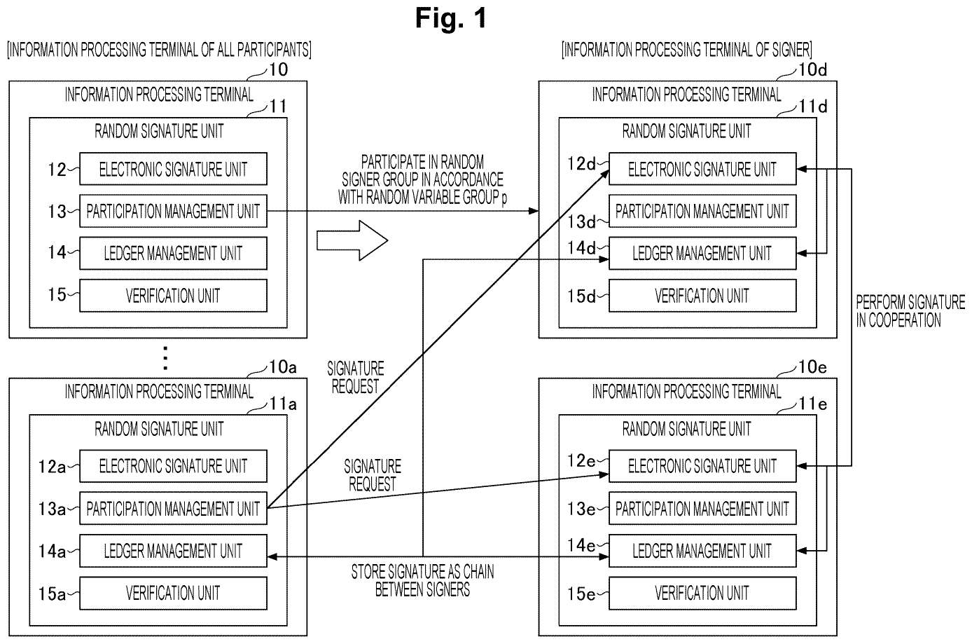

Hereinafter, embodiments of the present invention will be described with reference to FIGS. 1 to 11.

First, an overall configuration of an existence proof system according to the embodiment will be described with reference to FIG. 1. It is an overall configuration diagram of the existence proof system according to the embodiment.

The existence proof system is constructed by a plurality of information processing terminals of participants of electronic signatures (hereinafter may be simply referred to as “signatures” in some cases). In FIG. 1, the information processing terminals of the participants are illustrated on the left side, and one or more information processing terminals of participants who have become signers, among the information processing terminals on the left side, are illustrated on the right side. Here, an information processing terminal 10 of any participant and an information processing terminal 10a of a signature requester a are illustrated. Further, an information processing terminal 10d of a signer d, and an information processing terminal 10e of a signer e are illustrated, where the signer d and singer e have become signers, among the participants.

Here, in FIG. 1, each of the signers d and e of the information processing terminals 10d and 10e randomly participates in a signer group in accordance with a random variable p. The information processing terminal 10a requests the information processing terminals 10d and 10e for signatures. In addition, when a request for a signature is received, the information processing terminals (in this case, the information processing terminals 10d and 10e) of all signers cooperate to execute the signature. Furthermore, the signature is stored among the information processing terminals (in this case, the information processing terminals 10d and 10e) of all the signers, and is also stored in the information processing terminal 10a of the requester a.

Note that a functional configuration of an arbitrary information processing terminal 10 will be described later. The arbitrary information processing terminal 10 also includes information processing terminals 10a, 10d, and 10e.

### <Use Case>

On a posting (information processing terminal 10a) side, a time stamp for a post (a blog, a message, or the like), a transaction result certificate, a receipt certificate, or the like is performed in a decentralized manner without depending on a TTP.

On a receiving (information processing terminal 10d) side, time stamp verification of information presented by the other party is performed in a decentralized manner without depending on the TTP.

### <Application Example>

(1) In order to guarantee a data creation time for a message written or a photograph captured in a smartphone (an example of the information processing terminal 10a), or a mail text of transaction, or the like, the signature requester adds chain information locally to a signature target and requests a randomly selected signer. The participant of the signature implements a free electronic signature by performing automatic signature using free resources of the smartphone ((an example of the information processing terminals 10d and 10e)).

(2) The signature requester is the same as in (1) above, but the participant of the signature is assumed to be a mining person of a blockchain. The participant of the signature performs the signature with the free resources of the mining.

### [Hardware Configuration]

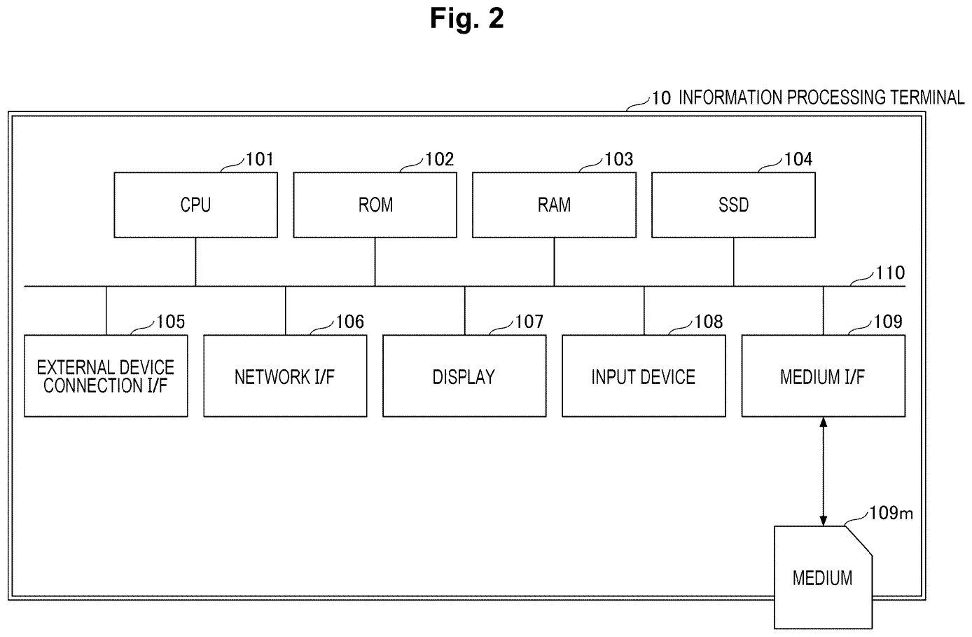

FIG. 2 is an electrical hardware configuration diagram of the information processing terminal.

As illustrated in FIG. 2, the information processing terminal 10 as a computer includes a CPU 101, a ROM 102, a RAM 103, an SSD 104, an external device connection interface (I/F) 105, a network I/F 106, a display 107, an input device 108, a medium I/F 109, and a bus line 110.

Among these, the CPU 101 as a processor controls the entire operation of the information processing terminal 10. The ROM 102 stores a program used for driving the CPU 101, such as IPL. The RAM 103 is used as a work area of the CPU 101.

The SSD 104 reads or writes various kinds of data under the control of the CPU 101. Note that a hard disk drive (HDD) may be used instead of the SSD 104.

The external device connection I/F 105 is an interface for connecting various external devices. Examples of the external devices in this case include a display, a speaker, a keyboard, a mouse, a USB memory, a printer, and the like.

The network I/F 106 is an interface for data communication via a communication network such as the Internet.

The display 107 is a type of display means such as liquid crystal or organic electro luminescence (EL) that displays various images.

The input device 108 is a type of input means that performs selection and execution of various instructions, selection of a processing target, movement of a cursor, and the like. Examples of the input device 108 include a pointing device, a touch panel, and the like.

The media I/F 109 controls reading or writing (storing) of data from or in a recording medium 109m such as a flash memory. Examples of the recording medium 109m also include a DVD, a Blu-ray Disc (registered trademark), and the like.

The bus line 110 is an address bus, a data bus, or the like for electrically connecting each component such as the CPU 101 illustrated in FIG. 2.

### [Functional Configuration of Information Processing Terminal]

Returning to FIG. 1, any information processing terminal 10 includes a random signature unit 11. The random signature unit 11 is a function implemented by a command by the CPU 101 in FIG. 2 on the basis of a program. Furthermore, the random signature unit 11 includes an electronic signature unit 12, a participation management unit 13, a ledger management unit 14, and a verification unit 15 as subordinate functional units.

The random signature unit 11 mediates a subordinate functional unit and provides a user UI of “information posting” and “ledger verification”.

The electronic signature unit 12 performs signature execution and signature verification in cooperation with the information processing terminal 10 of the (ring) signer by performing time matching and signature by existence proof (time stamp) on the signature request information.

The participation management unit 13 makes a participation determination with a time span agreed in the signature system and raises a hand as the terminal of the signer with a probability p. Furthermore, the participation management unit 13 raises a hand as a terminal of the signer also at the time of information posting, and simultaneously shares its own signature request.

The ledger management unit 14 manages a ledger of a local chain closed in each terminal. Furthermore, at the time of participation as a signer, the ledger management unit 14 shares the latest state of the ledger with the information processing terminal of a person who has become another signer, generates a new signature on the basis of information indicating the latest state, and connects the new signature to the managed ledger as the local chain of signatures, thereby ensuring security.

The verification unit 15 verifies the signature and the condition, and performs matching of the local chain of the presented signature with the local chain of the signature of the host terminal to search for a matching signature.

Note that the random signature units 11a, 11d, and 10e of the respective information processing terminals 10a, 10d, and 10e have functions similar to those of the random signature unit 11. Similarly, the electronic signature units 12a, 12d, and 12e have functions similar to those of the electronic signature unit 12. The participation management units 13a, 13d, and 13e have functions similar to those of the participation management unit 13. The ledger management units 14a, 14d, and 14e have functions similar to those of the ledger management unit 14. The verification units 15a, 15b, and 15e have functions similar to those of the verification unit 15.

### [Concept of Security of Signature]

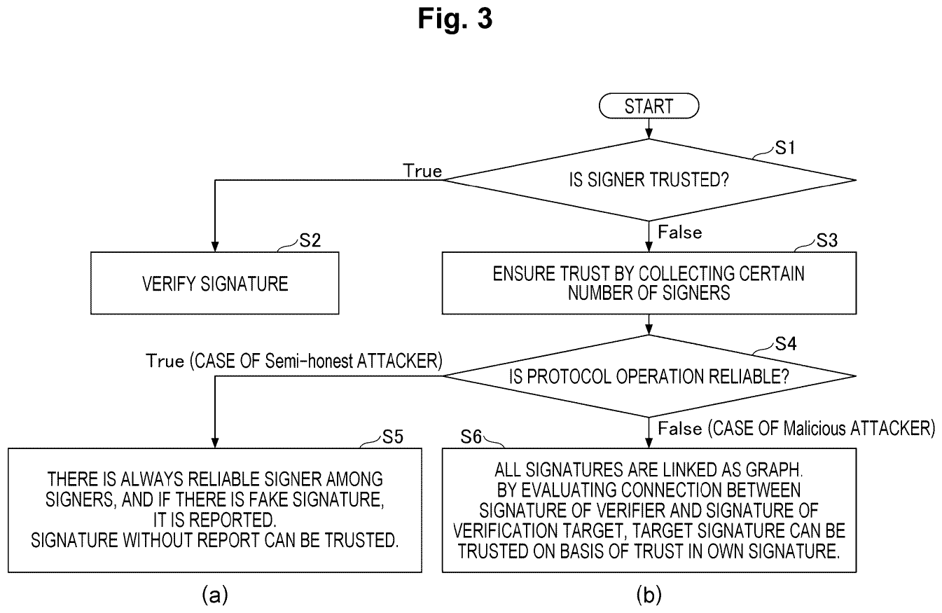

Next, before describing the processing of the present embodiment, a concept of signature security will be described with reference to FIG. 3. FIG. 3 is a flowchart illustrating the concept of the signature security. Here, the concept of the signature security is illustrated.

S1: is the signer trusted?

S2: if the signer is trusted (S1; True), the signature is verified.

S3: if the signer is not trusted (S1; False), trust is ensured by collecting a certain number of signers.

S4: further, whether a protocol operation is trusted is verified.

S5: if the protocol operation is trusted (S4; True), that is, in a case of a semi-honest attacker, there is always a trusted signer among the signers, and if there is a forged signature, it is reported. In addition, a signature without a report is trusted.

S6: if the protocol operation is not trusted (S4; False), that is, for a malicious attacker, all signatures are linked as a graph. By evaluating the connection between the signature of the verifier and the verification target signature, the target signature can be trusted on the basis of trust in the own signature.

Note that, in the present embodiment, contents related to S3 to S6 are proposed.

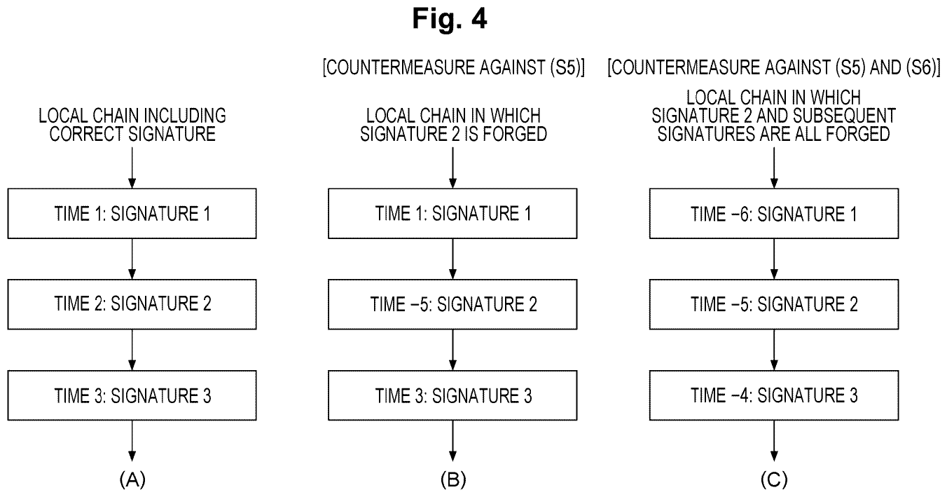

FIG. 4 is a diagram illustrating a countermeasure against the forged signature by the local chain.

FIG. 4(A) illustrates the local chain including a correct signature. This indicates verification (Pass) including chronological order.

FIG. 4(B) illustrates the local chain in which signature 2 is forged as a countermeasure target against S5 (a) in FIG. 3. By “time-5” of signature 2, verification including chronological order is NG.

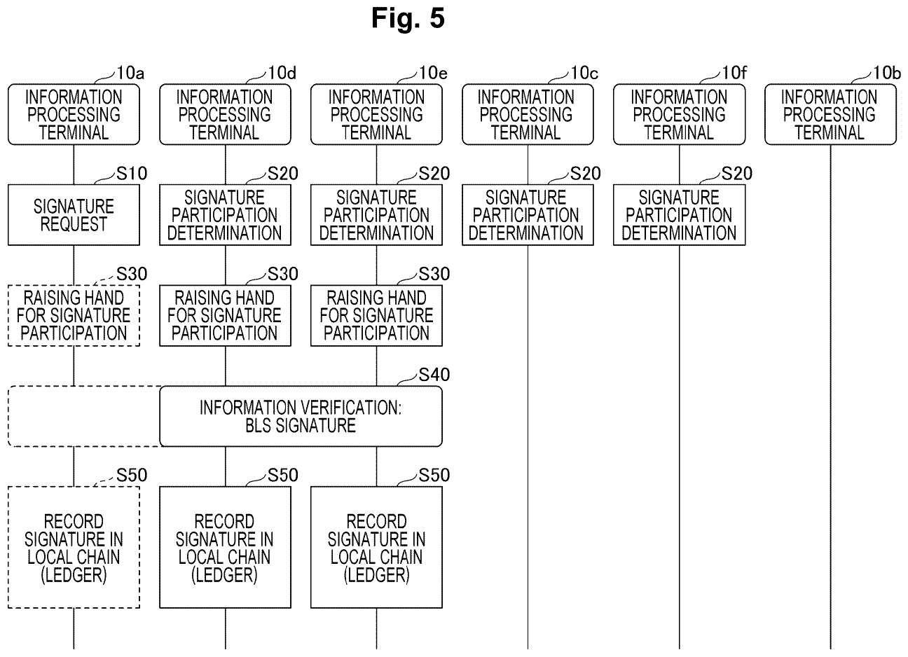

FIG. 5(C) illustrates the local chain in which signature 2 and subsequent signatures are all forged as a countermeasure target for S5 (a) and S6 (b) in FIG. 3. Even if continuous counterfeiting is performed, NG verification can be performed using a signature with a verifier chain.

### [Examination of Security (Reliability of Signer)]

Next, security examination (reliability of the signer) will be described.

As the reliability of the signer, security based on the number of signature participants is ensured.

### 1. Calculate the Number of Signature Participants According to Estimated Maximum Ratio of Attackers

When a ratio α of honest citizens is given, it is desired to calculate a minimum number of honest citizens. As an approach, a lower limit eg that becomes negligible (2−30=9.3132257e−10) is searched for by a probability test for a variation eg that can occur with respect to the ratio α of the honest citizens.

Some setting conditions, such as 51% or more, ⅔ or more, and ⅓ or more, are conceivable for the ratio α of honest citizens in accordance with the assumption of the blockchain. Since the signature is established if there is at least one honest citizen who correctly checks the time with the signature, it is desired to search for a minimum number of signature participants n with at least one honest citizen.

(1) When the number of attackers/the total number of participants <⅓ is satisfied, if there are 24 signers, one honest signer exists stochastically.

(2) When the number of attackers/the total number of participants <½ is satisfied, if there are 37 signers, one honest signer exists stochastically.

(3) When the number of attackers/the total number of participants <⅔ is satisfied, if there are 63 signers, one honest signer exists stochastically.

For example, in the above (1), in a case where the number of attackers among all the participants is less than ⅓, if there are 24 signers, it is considered that at least one honest person is included. There is only a probability of about (1/9)\hat{ }−10 that even one honest person is not included, and thus it is based on the assumption that the case of zero honest persons cannot practically occur. Further, in the case of the above (1), if 24 signers are gathered, it can be derived from the ratio of attackers in the whole that there is at least one honest person. When it can be assumed that there are less than ⅓ of attackers, if 24 attackers are gathered, it can be said that one honest signer is always included.

2. Calculate a signature participation probability p corresponding to the number of signature participants and the number M of system subscribers (=denominator in the following example)

The present embodiment is characterized by deriving the probability p that there is always one honest person among signers.

When all of M terminals participate in a vote as a client of a specific round with a probability of p=n/M (determine in accordance with the Bernoulli distribution performing binary selection of join or not join), an upper limit and a lower limit of the number of participants can be calculated. As an approach, ec with which a probability of occurrence of a variation equal to or more than ec with respect to the probability of p becomes negligible (2\hat{ }−30=9.3132257e−10) by a probability test is searched for. The lower limit n* of the number of participants can be said to be M(p-ec) as a lower limit if ec having a sufficiently small probability exp (−KL(p−ec, p)n) that becomes n*=M(p−ec) can be selected.

(1) Example of signature participation probability in a case where at least 24 signers are gathered: p=64/100, 74/1000, 125/10000, and 1024/100000

(2) Example of signature participation probability in a case where at least 37 signers are gathered: p=68/100, 96/1000, 138/10000, and 1037/100000

(3) Example of signature participation probability in a case where at least 63 signers are gathered: p=89/100, 133/1000, 163/10000, and 1063/100000

### [Supplement]

Note that, as a supplement, an example of the probability p of signature participation is illustrated in a case where N signers are gathered so that at least one honest person among participants M is assured (for each condition of α).

Here, it is determined whether or not to become a signer on the basis of the probability to “participate as a signer if it is smaller than p, but not to participate if it is equal to or more than p”. This is visualized as rolling a die where “one becomes a signer if the result is smaller than p, and does not participate as a signer if the result is equal to or more than p”.

(1) α=⅓: if the attackers are equal to or less than ⅔M, and the honest users are equal to or more than ⅓M,
for N=63 n=89 M=100 p=0.89
for N=63 n=125 M=1000 p=0.125
for N=63 n=130 M=10000 p=0.013
for N=63 n=134 M=100000 p=0.00134
for N=63 n=164 M=1000000 p=0.000164

For example, in the third example from the top, if there are 10,000 participants, about 130 of them are signers. In this case, it is sufficient to store information having a data capacity 0.013 times that of the case of the existing blockchain.

(2) α=½: if the attackers are equal to or less than ½M, and the honest users are equal to or more than ½M,
for N=37 n=69 M=100 p=0.69
for N=37 n=89 M=1000 p=0.089
for N=37 n=93 M=10000 p=0.0093
for N=37 n=98 M=100000 p=0.00098
for N=37 n=138 M=1000000 p=0.000138

(3) α=⅓: if the attackers are equal to or less than ⅓M, and the honest cs are equal to or more than ⅔M,
for N=24 n=56 M=100 p=0.56
for N=24 n=70 M=1000 p=0.07
for N=24 n=71 M=10000 p=0.0071
for N=24 n=75 M=100000 p=0.00075
for N=24 n=125 M=1000000 p=0.000125

### [Examination of Security]

Next, the reliability of the signature information will be described as a security examination.

### <Reliability 1 of Signature Information>

### 1. Case of Semi-Honest Attackers:

When the signer does not deviate from operation protocol, the security can be verified only by an electronic signature performed on individual information based on the probability of signature participation in general.

If only one user (participant) is honest, another participant (attacker) may perform signature excluding the user who is honest. To counter this, the honest user can share objection information regarding a time error and pass the objection information to the next signature to detect the forged signature.

### 2. Case of Malicious Attackers:

Considering an attacker who deviates from the protocol and manipulates the random variable p, it is possible to perform signature only by the attacker by performing signature participant management in another system in which the honest user does not enter.

(1) In a case where only one “attack with a signature for existence proof=signature in the incorrect existence ‘past time’” is performed, validity verification of the target signature can be performed by comparing the local chain of the signature with the preceding and subsequent signature times (times).

(2) In a case where “attack with a signature for existence proof=signature until the correct time in the incorrect existence ‘past time’” is continuously performed, an error in the target signature cannot be detected by comparing the local chain of the signature with the preceding and subsequent signature times (times), Since the signature is continuously performed, the signature continues only by the attacker for the duration of the signature, and is not signed by the honest user. Therefore, verification can be performed by examining the connection in the signature chain from the honest user to the verification target signature.

In a case where a malicious attacker is considered at the time of signature verification in consideration of the above, the verification requester not only sends the signature to the verifier, but also collects the signature recorded after the signature to be verified and performs existence confirmation by comparing the signature with the signature of the verifier.

### <Reliability 2 of Signature Information>

Verifiability when Assuming Malicious Attackers:

The possibility of uniquely adding a signature by deviating from the protocol as Sybil will be considered. In particular, since each individual manages its own signature, presented information has to be used for the signature of another person.

(1) In order to detect forgery of the local chain of a presented signature itself, it is conceivable to use a period until the signature of the verifier enters the local chain of the signature as a buffer period. In that case, depending on the signature participation probability p of the system, the buffer period greatly varies from several minutes to several days.

In the case of the overlap probability of the local chain between the verifier and a signature information holder: p², when a holder and a verifier of signatures verifying γ signatures made immediately after the signature desired to be verified are brought together, the probability that the verifier and the signer have never made the same signature is (1−p²)^{γ}, but since the γ signatures have already been implemented, (1−p)^{γ} is obtained as a posterior probability.

The number γ of signatures satisfying (1−p)^{γ}<negligible can be calculated on the basis of p, and it can be indicated that the signature by the verifier is always present within a certain number of signatures. However, considering the interval of the signature (a round period in which the signature does not participate with a probability of p), a certain buffer period occurs before verification can be performed.

(2) As a method of shortening the buffer in the most recent case (1), a signature leading to a tree shape and a spread of persons concerned. Each time the system participates in the signature as a Bernoulli trial, it is jointly signed by multiple third parties. By following the tree, it has been found that it is necessary to verify 500 to 900 signatures (in the case of one signature every 10 seconds, a delay time of about 5 hours occurs) until everyone can verify the signature of the other person by simulation.

### [Determination of Member for Each Signature Round]

Next, determination of participating members for each signature round will be described.

As synchronization of processing in the information processing terminal (for example, the information processing terminals 10d and 10e) of each signer, the information processing terminal of each signer refers to an external time server or another blockchain, and each signer participates in a distributed hash table (DHT) or the like created for each time of a few seconds span. The signing begins after placing a certain communication buffer.

### [Condition of Signature and Flow of Processing]

Next, a signature condition and a processing flow will be described. Here, use of a Boneh-Lynn-Shacham (BLS) signature will be described.

### 1. Information Synchronization

(1) The information processing terminal 10 determines “entire information to be signed” target_m by consensus among participants such as Raft (distributed consensus algorithm), a rule, or the like. In a case where there is a time error, the information processing terminal 10 makes an objection by the honest user. In a case where many Byzantine nodes do not raise any objection, the information processing terminal 10 distributes, in the next round, the “entire information to be signed” target_m agreed on by the honest user with the “participant node list” and evidence of the objection (hash information of the current time of the external decentralized base), thereby preventing post-distribution of the Byzantine node and the signature created in all rounds.

(2) The information processing terminal of each signer i performs the pairing signature on the “entire information to be signed” target_m and the message “m_i=target_m+t_i” created from the latest transaction hash t_i of the local chain.

### 2. Signature Sharing

(1) The information processing terminal 10 confirms the “list of signatures” by Raft.

(2) The information processing terminal 10 generates one signature s by aggregating the pairing signatures (Reference Literature 1).

(3) Each signer i and signature requester j connects a combination of the signature s and target_m to the local chain.
<Reference Literature 1> Aggregate and Verifiably Encrypted Signatures from Bilinear Maps (https://crypto.stanford.edu/~dabo/pubs/papers/aggreg.pdf)

### 3. Signature Verification

(1) The information processing terminal 10 checks whether the signature is shared as the Byzantine node.

(2) The information processing terminal 10 performs signature verification using the signature s, the latest transaction hash t_i of the target_m+ local chain, and a public key of i by aggregation of the pairing signatures (Reference Literature 1).

### [Processing of Existence Proof System]

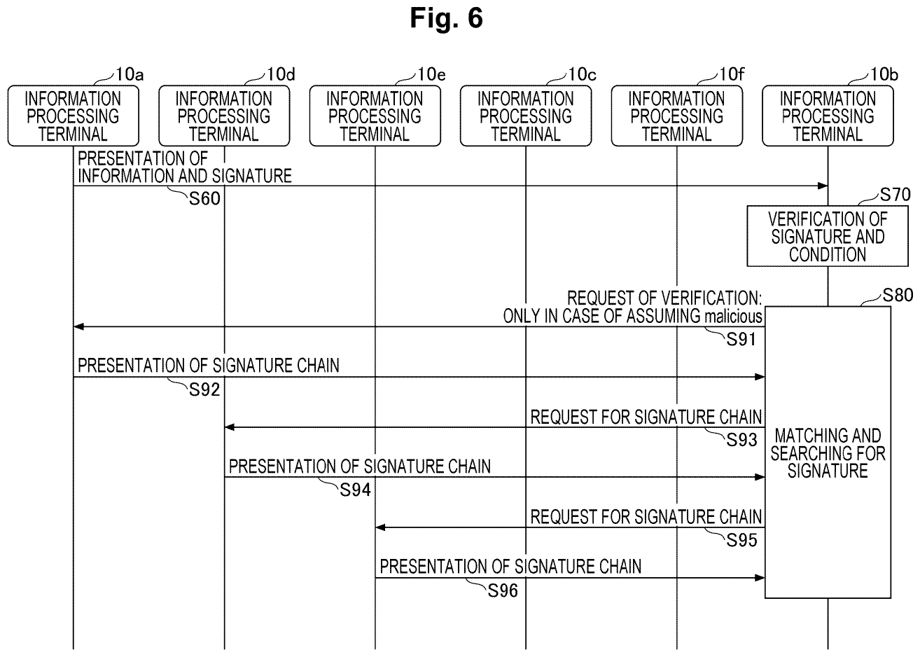

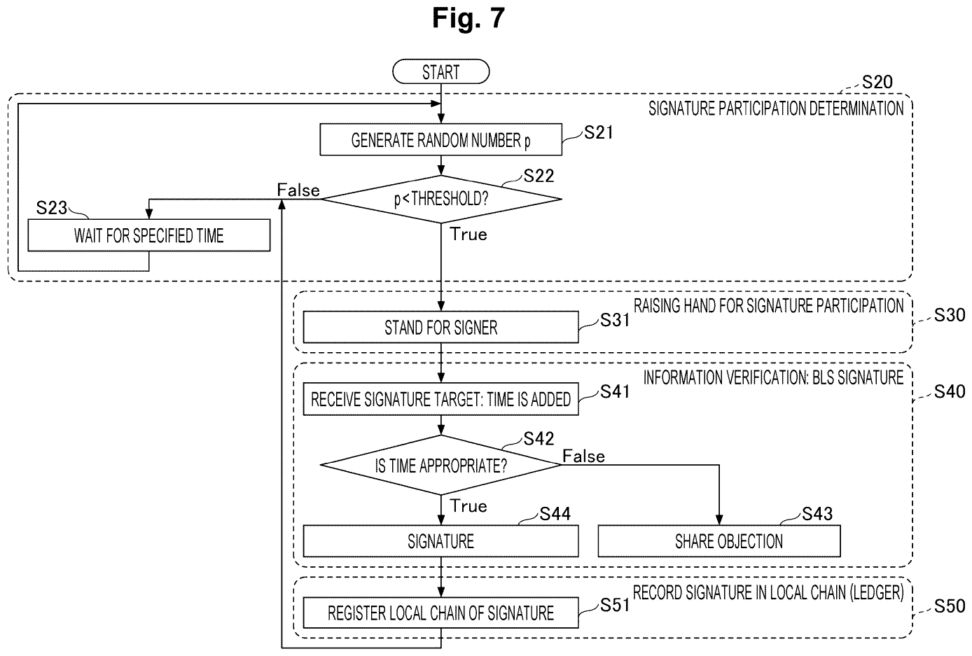

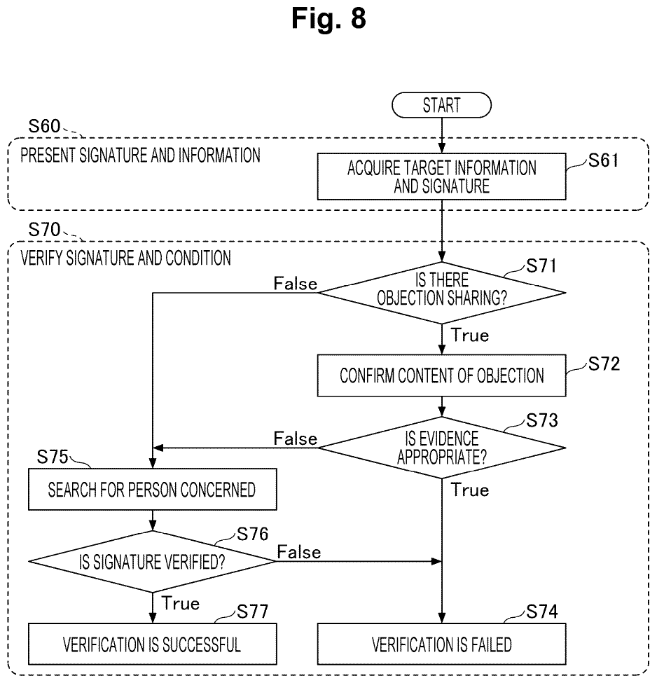

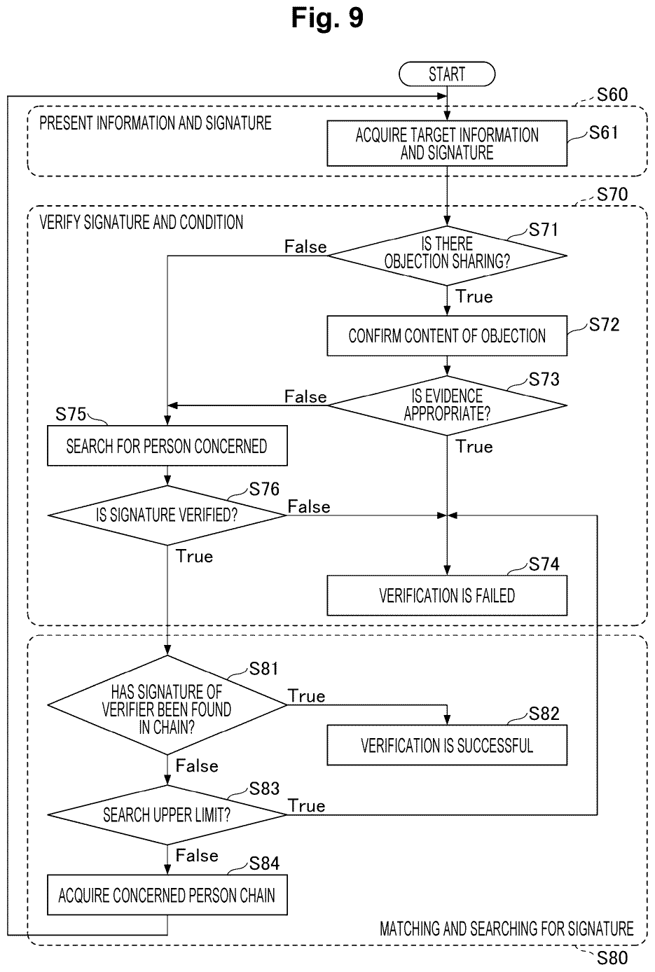

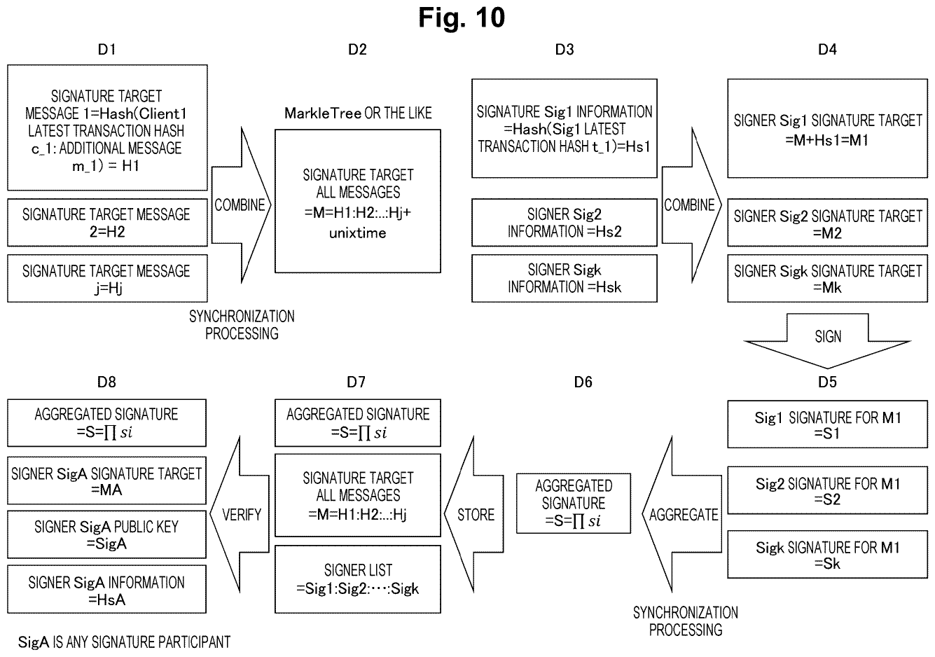

Next, processing of the existence proof system according to the present embodiment will be described with reference to FIGS. 5 to 10. FIGS. 5 and 6 are sequence diagrams illustrating processing of the existence proof system. In particular, FIG. 5 illustrates processing at the time of information posting (at the time of signature). In particular, FIG. 6 illustrates processing at the time of reference (at the time of signature verification). FIG. 7 is a flowchart illustrating processing related to a signature. FIG. 8 is a flowchart illustrating processing related to verification that does not assume malicious behavior. FIG. 9 is a flowchart illustrating processing related to verification assuming malicious behavior. FIG. 10 is a diagram illustrating an example of content of data in each processing.

Here, as illustrated in FIGS. 5 and 6, the information processing terminals 10a, 10b, 10c, 10d, 10e, and 10f of the respective participants a, b, c, d, e, and f are illustrated but only six information processing terminals are illustrated due to space limitations, and more information processing terminals participate in the actual operation. In FIGS. 5 and 6, the information processing terminal 10a is a terminal of an information transmission source (signature request source). The information processing terminals 10d and 10e are terminals that participate in the signature by establishing p. The information processing terminals 10c and 10f are terminals that do not participate in the signature. The information processing terminal 10b is a terminal of a signature verifier (himself/herself performs signature at a different timing).

Note that timing at which each piece of data (D1 to D8) in FIG. 10 is handled will also be described in combination with processing.

### <Processing at Time of Information Posting (at Time of Signature)>

S10: as illustrated in FIG. 5, the participation management unit 13a of the information processing terminal 10a requests the information processing terminals of all the other participants for signature.

S20: the participation management unit 13d of the information processing terminal 10d determines signature participation. Note that similar processing is also performed in the information processing terminals 10e, 10c, and 10f. Here, the processing S20 will be described in detail with reference to FIG. 7.

S21: the participation management unit 13d generates a probability (random number) p.

S22: the participation management unit 13d determines whether p<threshold value is satisfied.

S23: if p<threshold value is not satisfied (S22; False), the participation management unit 13d waits for the specified time, and returns to the processing S21. On the other hand, if p<threshold value is satisfied (S22; True), the processing proceeds to the next processing S31.

S30 (S31): returning to FIG. 5, the participation management unit 13d of the information processing terminal 10d stands as a candidate for the signer by raising a hand for signature participation (see D1 to D2 in FIG. 10). When the participation management unit 13d raises the hand, the participant of the information processing terminal 10d is treated as a signer. The information processing terminal 10e also performs similar processing. Note that the information processing terminal 10a of the signature request source may participate in the signature.

S40: the electronic signature unit 12d of the information processing terminal 10d of the participant who has become the signer and the electronic signature unit 12e of the information processing terminal 10e of the participant who has become the signer perform information verification using the BLS signature (see D3 to D6 in FIG. 10). Note that, in a case where the information processing terminal 10a of the signature request source participates in the signature, the electronic signature unit 12a of the information processing terminal 10a also performs information verification using the BLS signature. Here, processing S40 by the electronic signature unit 12d will be described in detail with reference to FIG. 7. The same applies to the processing of the electronic signature unit 12e, and in a case where the information processing terminal 10a participates in the signature, the same applies to the processing of the electronic signature unit 12a.

S41: the electronic signature unit 12d adds time to the signature target as the signature target reception.

S42: the electronic signature unit 12d determines whether the added time is appropriate.

S43: if the time is not appropriate (S42; False), the electronic signature unit 12d shares the objection. Specifically, the electronic signature unit 12d registers the objection information in a shared system that can be accessed by the participant.

S44: if the time is appropriate (S42; True), the electronic signature unit 12d performs the signature, and proceeds to the next processing 51.

S50 (S51): returning to FIG. 5, each of the ledger management units 14d and 14e of the information processing terminals 10d and 10e records the signature in the local chain (ledger) (see D7 and D8 in FIG. 10). Note that, in a case where the information processing terminal 10a of the signature request source participates in the signature, the ledger management unit 14a of the information processing terminal 10a also records the signature in the local chain (ledger). Note that, after the processing of S51 in FIG. 7, the processing returns to processing S23.

Thus, the description of the processing at the time of information posting (at the time of signature) ends.

### <Processing at Time of Reference (at Time of Signature Verification)>

S60: as illustrated in FIG. 6, the random signature unit 11a of the information processing terminal 10a, which is a request source of verification of the signature, presents target information and the signature to the information processing terminal 10b of the verifier b. Note that the information processing terminal 10b includes the random signature unit 11 similar to that of the other information processing terminals 10.

S61: as illustrated in FIG. 8, the random signature unit 11b of the information processing terminal 10b acquires the target information and the signature according to the processing S60.

S70: returning to FIG. 6, the verification unit 15b of the information processing terminal 10b verifies the signature and the condition. Here, processing 70 of verifying the signature and the condition will be described in detail with reference to FIG. 8.

S71: the verification unit 15b accesses the shared system that the participants can access, and determines whether there is objection sharing.

S72: if there is objection sharing (S71; True), a verification unit 15bd checks the contents of the objection.

S73: then, the verification unit 15b determines whether or not a trail is valid.

S74: if the trail is valid (S73; True), the verification unit 15b determines that the verification is failed.

S75: on the other hand, if there is no objection sharing (S71; False), the verification unit 15b searches for persons concerned (participants). Note that if the trail is invalid (S73; False), the processing S75 is performed.

S76: the verification unit 15b verifies the signature and determines whether or not the signature is successful.

S77: if it is successful (S76; True), the verification unit 15b determines that the verification is successful. On the other hand, if it is not successful (S76; False), the verification unit 15b determines that the verification is not successful.

As described above, the processing related to the verification that does not assume malicious ends. This is processing in the case of S5 (approach of (a)) in FIG. 3. When the implementation and the protocol operation are not reliable, processing 80 and subsequent processing in FIG. 6 are subsequently executed on the basis of S6 (approach of (b)) in FIG. 3.

S80: as illustrated in FIG. 6, the verification unit 15b of the information processing terminal 10b performs matching of the local chain of the presented signature with the local chain of the signature of the host terminal, and searches for a matching signature.

Here, the processing S80 and S91 to S96 by the verification unit 15b will be described in detail with reference to FIGS. 6 and 8. Note that, even in the case of processing related to verification assuming malicious, the processing is similar to the processing in the first half of verification that does not assume malicious in FIG. 8 (S61 and S71 to S76), and thus the description of the pieces of processing will be omitted.

S91: in FIG. 8, even if the signature verification is successful in processing S76 (S76; True), the verification unit 15b further makes a verification request to the information processing terminal 10a that is a verification request source.

S92: the ledger management unit 14a of the information processing terminal 10a presents the local chain of the signature managed by the host terminal (10a) to the verification unit 15b of the information processing terminal 10b as a response of the processing S91.

S93: further, the verification unit 15b requests the blockchain of the signature from the information processing terminal 10d of the participant (signer). In this case, the verification unit 15b also transmits time information before and after the time (for example, about three hours) on the basis of the time of the blockchain of the signature presented from the information processing terminal 10a.

S94: as a response to the processing S93, the ledger management unit 14d of the information processing terminal 10d narrows down and presents a local chain of a predetermined signature corresponding to the time information in the local chain of signatures managed by the host terminal (10d).

S81: subsequently, the verification unit 15b determines whether the signature of the host terminal (10b) of the verifier has been found in the local chain presented from the information processing terminal 10d.

S82: if the signature of the verifier is found (S81; True), the verification unit 15b determines that the verification is successful.

S83: if the signature of the verifier is not found (S81; False), the verification unit 15b determines whether or not a search upper limit is set in the local chain of all the presented co-signers. In the case of the search upper limit (S83; True), the processing proceeds to processing 74, and the verification unit 15b determines that the verification has failed.

S84: if it is not the search upper limit (S83; False), the verification unit 15b acquires a local chain of another person concerned. Thus, the processing returns to processing S61, and similar processing is performed. Note that the other person concerned is, for example, the signer e of the information processing terminal 10e in FIG. 6. Therefore, the verification unit 15b requests the information processing terminal 10e for the local chain of the signature, similarly to the processing S93 (S95). Further, the verification unit 15b receives presentation of the local chain of the signature from the information processing terminal 10e, similarly to the processing 894.

As described above, the processing related to the verification assuming malicious ends.

### Effects of Present Embodiment

As described above, according to the present embodiment, it is possible to reduce costs for storage usage, network communication, incentive for participants, and the like while ensuring the security of the existence proof. For example, the participant only needs to own information related to the signature periodically performed by the participant himself/herself, and if the signature participation probability is about p≈1/1000, the participant only needs to manage the ledger of 1/1000 in both the communication amount at the time of signature and the stored data amount as compared with the existing blockchain (distributed ledger).

Hereinafter, effects will be described in detail.

### <Security>

In order to ensure the security of the existence proof, it is only necessary to ensure that there is at least one honest person among the signers, and n persons are gathered on the basis of random signature participant selection, thereby ensuring the security of the signature itself by the multi-person signature scheme using the signature condition that can probabilistically indicate that one or more of the persons are honest. Security that can be confirmed by signature chain verification that can perform probabilistically identification as long as it is a forged certificate signature from participant conditions of the signature and the context of the signature is ensured. Security against Sybil is ensured by providing a correspondence from a participant of any signature to its own signature.

### <Cost>

In order to secure a sufficient number of signers, the signature requester requires to store a trail of a certain number of signature participation and participation candidacy, but excludes a node for resource provision=cost increase factor. The storage capacity and the communication volume are reduced by relaxing the data storage condition from the entire data storage to the storage of the host terminal information.

### <Reliability of Signer>

If an upper limit of the ratio of attackers can be assumed, correctness of the signature is guaranteed by collecting a number of signers who can be probabilistically guaranteed to be safe.

That is, a system is assumed in which the information processing terminals 10 of all the participants determine whether to participate in the signature or not in each round in accordance with the probability of p, and perform the signature only by the information processing terminals of the participants (the persons who become the signers). The upper limit and the lower limit of the number of people participating in the signature in any round can be calculated as probabilities by the Chernoff bound on the basis of the KL information amount with respect to the Bernoulli distribution of p. A method of calculating the number of participants will be described later.

Similarly, assuming the ratio of the attacker terminal among the information processing terminals of all the participants, the lower limit of the honest users (participant) among the participants of the signature can also be calculated. A method of calculating the number of participants will be described later.

In the case of performing the existence proof (time signature), a denial or collusion attack does not succeed as long as one or more honest users (participants) can be expected, and thus the security as the existence proof can be ensured.

### <Reliability of Signature Storage>

In order to be able to verify long-term validity of the signature, the requester of the signature stores the signature information of the host terminal in the local chain by the host terminal (for example, the information processing terminal 10a). A signature recipient (a person who has become a signer) continuously participates in the signature even after receiving the signature, and connects the executed signature to the local chain of the host terminal (with reference to the latest transaction of the local chain). Thus, the chain stored by each participant is regularly expanded, and the resistance to falsification of past signatures is enhanced by both the signer and the signature requester.

### <Reliability of Signature Information>

When not deviating from the protocol of collecting signers, the reliability is confirmed by signature verification and objection verification. In a case where it is possible to deviate from the protocol of collecting the signers, the correctness of the signature time is ensured by self-signature search from any verifier (participating in the signature) by following the connection between the local chains owned by each signer.

In other words, in a case where the forged signature “at different time” is made by the semi-honest attacker following the probability p, since there is always an honest participant in the signature round, an error can be detected. Furthermore, in a case where a malicious attacker who does not follow the probability p makes the forged signature “at a different time”, the order relationship in each loc al chain is inconsistent, or the forged signature can be detected by using a small number of joint signatures with the local chain of another person.

### (Method of Calculating Number of Participants)

### (1) Upper and Lower Limits of the Number of People Participating in Signature in any Round

When all of the M information processing terminals participate in a vote as a client of a specific round with a probability of p=n/M (determine in accordance with the Bernoulli distribution performing binary selection of join or not join), an upper limit and a lower limit of the number of participants can be calculated.

As an approach, the information processing terminal 10 searches for e_c with which the probability that a variation of e_c or more occurs with respect to the probability p becomes negligible (2\hat{ }−30=9.3132257e−10) by a probability test.

The lower limit n\hat{ }* of the number of participants can be said to be M(p−e_c) if e_c having a sufficiently small probability exp (−KL(p−e_c, p)n) that becomes n\hat{ }*=M(p−e_c) can be selected.

The upper limit n\hat{ }~ of the number of participants can be said to be M(p+e_c) as the upper limit if e_c having a sufficiently small probability exp (−KL(pte_c, p)n) that becomes n\hat{ }~=M(pte_c) can be selected.

### (2) Lower Limit of Honest Users Among Signature Participants

Given a ratio α of honest citizens (honest users), a ratio γ of attack servers, and a number m of transactions in a block, a lower limit of the honest citizens number can be calculated.

As an approach, the information processing terminal 10 searches for e_g and e_f with which the upper limit e_g of a variation that can occur with respect to the ratio of honest citizens α and the upper limit e_f of a variation that can occur with respect to a case where m times of writing are all made as attack servers become negligible (2\hat{ }{−30}=9.3132257e−10) by the probability test.

### [Others]

The present invention is not limited to the foregoing embodiment and may be configured or processed (operated) as follows.

(1) The information processing terminal 10 can also be implemented by a computer and a program, and the program can be recorded on a (non-transitory) recording medium or provided via the communication network such as the Internet.

(2) In the above embodiment, the information processing terminal 10 is, for example, a laptop computer, a desktop computer, a tablet terminal, a smartphone, a smart watch, or the like.

(3) Each of the CPUs 101 and 501 may be not only a single CPU but also a plurality of CPUS.

Reference Signs List

| | |
|---|---|
| 10 | Information processing terminal |
| 11 | Random signature unit |
| 12 | Electronic signature unit |
| 13 | Participation management unit |
| 14 | Ledger management unit |
| 15 | Verification unit |

1. An information processing terminal configured to perform electronic signature based on existence proof, the information processing terminal comprising:
circuitry configured to:
generate a random number for each of individual participants of the electronic signature,
determine whether the random number is less than a threshold value, and
participate as the information processing terminal that is related to a signer, upon determining that the random number is less than the threshold value.

2. The information processing terminal according to claim 1, wherein the circuitry is configured to perform, in cooperation with a second information processing terminal related to a second signer, the electronic signature through time synchronization and existence proof.

3. The information processing terminal according to claim 2, wherein the circuitry is configured to manage a ledger of a local chain, and share a latest state of the ledger with the second information processing terminal when the second information processing terminal participates as the second signer.

4. The information processing terminal according to claim 3, wherein the circuitry is configured to generate a new electronic signature based on information indicating the latest state of the ledger, and connect the new electronic signature to the ledger as the local chain.

5. An existence proof system comprising:
the information processing terminal according to claim 1; and
a second information processing terminal related to a second signer.

6. An information processing method executed by an information processing terminal that performs electronic signature based on existence proof, the information processing method comprising:
generating a random number for each of individual participants of the electronic signature;
determining whether the random number is less than a threshold value; and
participating as the information processing terminal that is related to a signer, upon determining the random number is less than the threshold value.

7. A non-transitory computer readable storage medium storing a program for causing a computer to execute the information processing method of claim 6.
